(19) United States
(12) Patent Application Publication
(10) Pub. No.: US 2013/0191775 A1
(43) Pub. Date: Jul. 25, 2013

(54) ADJUSTABLE USER INTERFACE

(71) Applicants: Richard James Lawson, Santa Clara, CA (US); Marguerite Letulle, San Mateo, CA (US); Chandar Kumar Oddiraju, Santa Clara, CA (US)

(72) Inventors: Richard James Lawson, Santa Clara, CA (US); Marguerite Letulle, San Mateo, CA (US); Chandar Kumar Oddiraju, Santa Clara, CA (US)

(21) Appl. No.: 13/358,305

(22) Filed: Jan. 25, 2012

(51) Int. Cl. G06F 3/048

(52) U.S. Cl. 715/784; 715/792

(57) ABSTRACT

Embodiments provide methods, apparatuses, and articles of manufacture for adjusting a user interface of a computing device. In various examples a size of the user interface is adjusted to accommodate application windows.

### BACKGROUND

Computing devices such as desktop computers, notebook computers, smart phones, and mobile devices, among others, may utilize a user interface on which various application windows may be disposed and/or integrated therewith. The application windows disposed within the user interface may be sized, arranged, and/or layered in accordance to a user's wishes.

### BRIEF DESCRIPTION OF THE DRAWINGS

FIGS. 1A-B illustrate block diagrams of computing systems in accordance with examples of the present disclosure;

FIG. 2 illustrates a display incorporating an adjusted user interface in accordance with an example of the present disclosure;

FIG. 3 illustrates a display incorporating a horizontally adjusted user interface in accordance with an example of the present disclosure;

FIG. 4 illustrates a computing device incorporating a vertically adjusted user interface' in accordance with an example of the present disclosure;

FIG. 5 illustrates a display transitioning between various modes in accordance with an example of the present disclosure;

FIGS. 6-10 illustrate various flow diagrams in accordance with examples of the present disclosure.

### DETAILED DESCRIPTION

In various computing devices such as, but not limited to, desktop computers, all-in-one computers, notebooks, slates, tablets, mobile phones, and smart phones, a user interface enables a user to interact with application windows and an operating system. An application window may be managed by the operating system (OS) integrated within the user interface and occupy a portion thereof. The user may interface with the application window in a variety of manners.

As a user launches, incorporates, or utilizes additional application windows, the user interface may not be large enough adequately display all of the application windows. To accommodate the application windows, the OS may stack, layer, or hide various application windows. In other words, on various computing systems the user interface (e.g., desktop) is limited to the physical size of the display. When the user opens up multiple application windows, those application windows begin to compete for space within the user interface.

In the present disclosure, an adjustable user interface is disclosed. The adjustable user interface has the capability of extending beyond the physical display size of the display thereby giving the user an ability to position or spread out over-lapping/layered application windows over a larger user interface. The adjustable user interface may be enabled to expand and shrink (i.e. reduce) based on various criteria including, but not limited to, the launching of applications, user interaction, closing of applications, enlarging application windows, and shrinking (i.e., reducing) application windows, among others.

The placement of application windows within the adjusted user interface may be automatic, where the operating system and application dispose the various application windows adjacent to one another and expand the user interface appropriately. Or alternatively, the placement of the application windows may be determined based upon input from a user.

Once the user interface is adjusted and the application windows disposed, a user may navigate the expanded or reduced user interface in multiple manners. For example, a user may interact with an expanded user interface displayed via a touch-screen by utilizing their finger to pan the desktop to the top, bottom, right or left. Alternatively, a mouse, trackball, or other peripheral may be utilized in conjunction with the adjustable user interface. These and other examples will be discussed in more detail here.

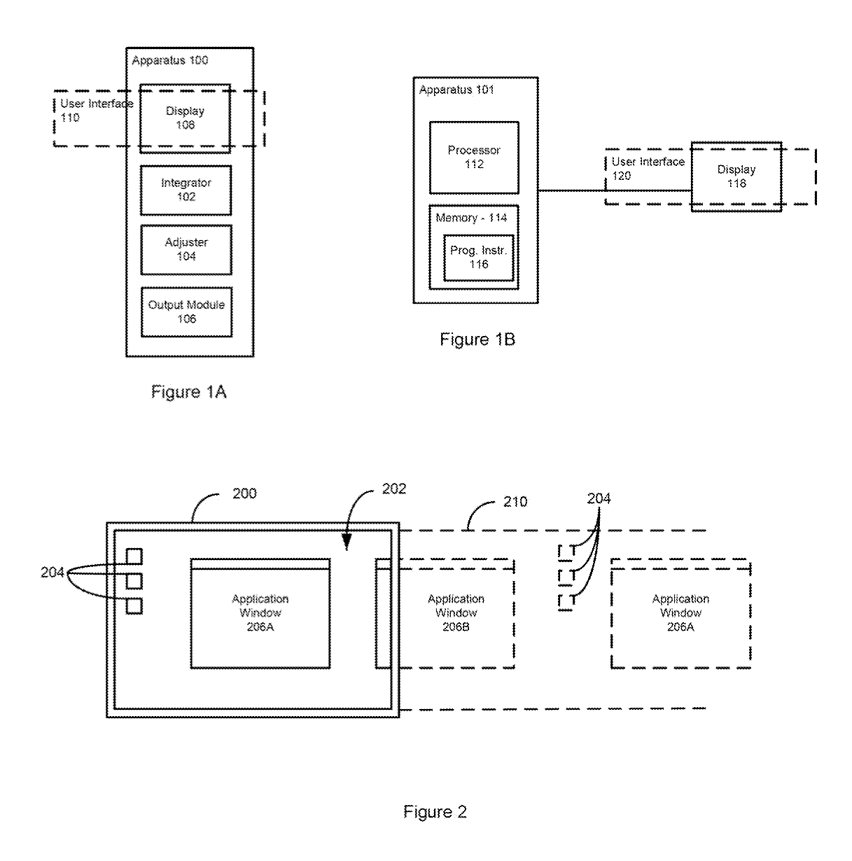

Referring to FIG. 1A, an apparatus 100 is illustrated in accordance with an example of the present disclosure. The apparatus 100 includes an integrator 102, an adjuster 104, and an output module 106. As stated previously, apparatus 101 may be a computing device such as, but not limited to, a desktop computer, an all-in-one computer, a notebook, a slate, a tablet, a mobile phone, a smart phone, or another device which utilizes a user interface 114 on which application windows are disposed or integrated therewith. Additionally, while illustrated as separate components, the integrator 102, adjuster 104, and output module 106 may be integrated together or in various combinations. The integrator 102, adjuster 104, and output module 106 may be integrated within an application specific integrated circuits) (ASIC) or be implemented in computer readable instructions executable by a processor as will be discussed with reference to FIG. 1B.

The integrator 102 may enable the apparatus 100 to integrate a first application window with a user interface 110. A user interface 110 is defined as a display screen of a display 108 on which various icons and application windows (not illustrated) may be moved, accessed, added, removed, or otherwise arranged. An example of a user interface 110 is a desktop of a computing system. An application window is defined as a viewing area on or integrated with the user interface 110 that the user is capable of working within. An application window is generally associated with a particular application. The integration may be in response to the launching of an application by a user, computing device, or other programming instruction. The integration of the first application window may dispose the first application window with the user interface 110 such that is fully visible on the display 108.

Adjuster 104 is coupled to the integrator 102 to adjust a size of the user interface 110 in response to integration of a second application window (not illustrated) with the user interface 110. The second application window may be disposed adjacent to the first application window such that a combined dimension of the first application window and the second application window is greater than one dimension of the display 108. For example, a display 108 may have a width of twenty inches (20 inches). The combined width of the first application window and the second application window may be greater than twenty inches. Alternatively, the combined height of the first application window and the second application window may be greater than the height of the display.

Output module 106 is coupled to adjuster 104 and is to output the second application window adjacent to the first application window within user interface 110 output via display 108. In various examples, the combined dimension of the first application window and the second application window is greater than one dimension of the display. With the combined dimension of the first application window and a second application window being greater than a dimension of the user interface 110, the output module 106 may fully display either the first application window or the second application window via the display 108. The display of the various application windows may be in response to a user input that is received via interaction with a predetermined area of the user interface 110. For example, a user may interact with an application bar disposed on a side of the user interface 110 output via display 108. Furthermore, the output module 106 may be configured to enable continuous scrolling through the first application window and the second application window in a single direction. In other examples, the output module 106 may be configured to switch the user interface 110 from a user interface expansion mode to a standard user interface mode. These and other examples will be fully discussed herein.

Referring to FIG. 1B, an apparatus 101 is illustrated in accordance with an example of the present disclosure. The apparatus 101 includes a processor 112, a memory 114, and programming instructions 116. The apparatus 101 may be coupled to a display 118 having an adjustable user interface 120. While illustrated as separate elements, in various examples, the display 118 may be incorporated into the apparatus 101. As stated previously, apparatus 101 may be a computing device such as, but not limited to, a desktop computer, an all-in-one computer, a notebook, a slate, a tablet, a mobile phone, a smart phone, or another device which utilizes a user interface 114 on which application windows are disposed or integrated therewith. Furthermore, while only one display is illustrated, additional displays may be incorporated without deviating from the present disclosure.

Processor 108 may be a general purpose processor, a graphics processor, an application specific integrated circuit (ASIC), or other device configured to access and execute instructions from a tangible, non-transitory computer readable medium. For example, processor 108 may be configured to access memory 110 to retrieve and execute programming instructions 112.

Programming instructions 106, if executed by processor 102, may enable the apparatus 101 to perform operations associated with the various components of FIG. 1A, namely the integrator 102, the adjuster 104, and the output module 106. For example, the programming instructions 116 if executed, may cause the apparatus 101 to integrate a first application window with a user interface 120. The integration may be in response to the launching of an application by a user, computing device, or other programming instruction. The integration of the first application window may dispose the first application window with the user interface 120 such that is fully visible on the display.

Additionally, the programming instructions 116, if executed may enable the computing device 101 to adjust a size of the user interface 120 in response to integration of a second application window with the user interface 120. The second application window may be disposed adjacent to the first application window such that a combined dimension of the first application window and the second application window is greater than one dimension of the display. Other functions described with reference to FIG. 1A may also be implemented in programming instructions 116, for examples, the functionality described with reference to the output module 106.

Referring to FIG. 2, a display incorporating an adjusted user interface as implemented by the apparatus of FIG. 1, for example, is illustrated. In FIG. 2, a display 200 is illustrated with a user interface 202. Integrated with the user interface 202 is a first application window 206A and icons 204. The first application window 206A may be disposed within the viewing area of the display 200. Because the user interface 202 is not large enough to display a second application window 206B in a non-overlapping manner, the apparatus 100, in response to integration of a second application window 206B, may adjust the size of the user interface 202 by expanding it to include expanded user interface 210.

In the illustrated example, the user interface 202 is adjusted to enable the first application window 206A and the second application window 206B to be disposed adjacent to one another in a non-overlapping manner. The adjustment comprises expanding the user interface 202 in one dimension. In various examples, one dimension may be associated either with a y-axis (vertical) or an x-axis (horizontal). As illustrated, the associated dimension is horizontal (i.e., x-axis). The expanded user interface 210 (illustrated with dashed lines) enables the first application window 206A and the second application window 206B to be disposed adjacent to one another. While only one application window may be viewed in its entirety at one time, a user may be enabled to scroll from one application window to the next. While not illustrated, more application windows may also be disposed within the expanded user interface 210. The additional application windows may disposed in overlapping or non-overlapping manners.

In the illustrated embodiment, the first application window 206A is viewable on the user interface 202. In addition, the first application window is disposed on the expanded user interface 210. In this manner, display 200 may display either the first application window 206A or the second application window 206B in response to a user selection. A user selection may be initiated in a number of manners. For example, a user may select an icon within a predetermined area of the user interface 202 or adjustable user interface 2010. The icon may be an associated icon at the bottom of the screen in a toolbar, or may be a selection of the application itself. In another example, a user may scroll continuously through any number of available application windows disposed within the adjusted user interface in a single direction. For example, as illustrated, if a user were to continually scroll to the right (e.g., in the adjustable user interface 210), the display 200 would display the second application window 206B, and subsequently, the first application window 206A, followed again by the second application window 206B (second occurrence not illustrated).

Additionally, while icons 204 are illustrated as being movable in connection with the expanded user interface 210, in other embodiments the icons 204 may remain static such that they are always viewable within the display area 200. In other words, the icons 204 may move in accordance with movement of the adjustable user interface 210 such that the icons 204 are continually output via the display 200. In the illustrated example, the application icons 204 are not static (e.g. continually output via the display 200). Rather, the icons 204 are moved into and out of view of the display 200 along with the first application window 206A and second application window 206B.

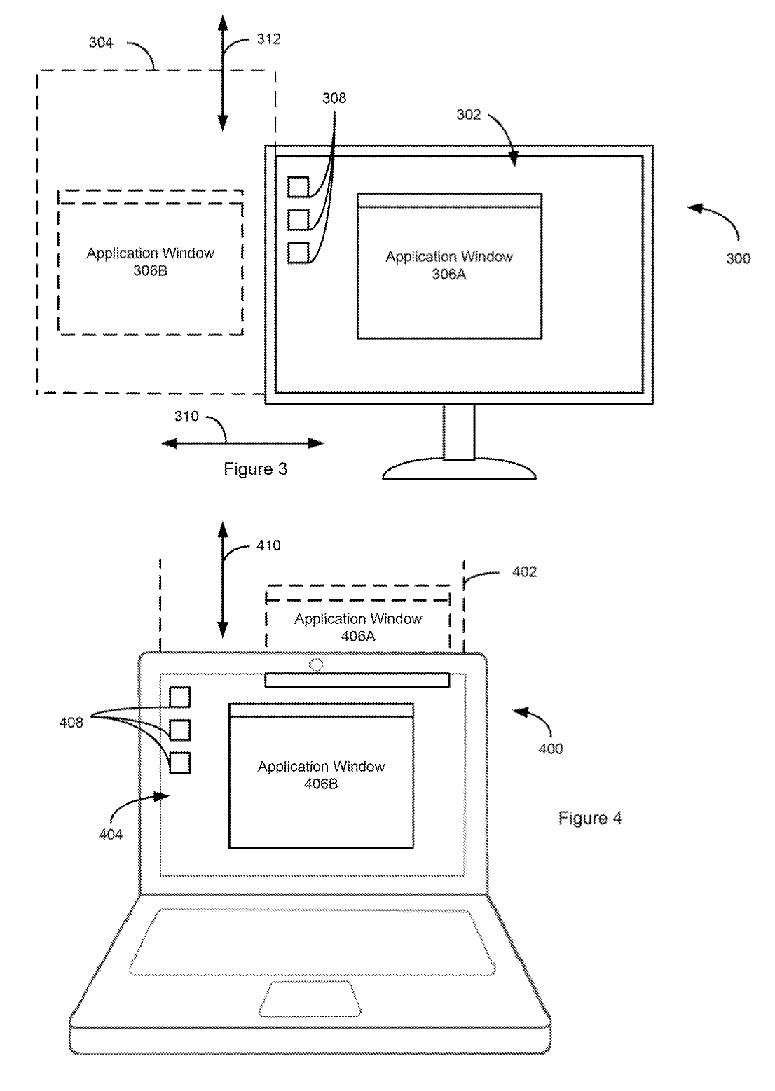

Referring to FIG. 3, a display incorporating a horizontally and vertically adjusted user interface is illustrated in accordance with an example of the present disclosure. Similar to FIG. 2, the display 300 may output a user interface 302 with icons 308 and a first application window 306A integrated therewith. In response to launch of a second application window 306B, the user interface 302 may be expanded to include expanded user interface 304. Expanded user interface 304, while illustrated as being on the left-side of the display 300 may also be on disposed on the right side of display 304. The expanded user interface 304 may be configured to scroll continuously through the various application windows 306A, 306B in a single direction illustrated by arrow 310. The single direction being associated with axis (i.e., left-right or updown). In other examples, the expanded user interface 304 may be configured to scroll to the end of the expanded user interface 304, upon meeting which, the user may only regress back along the axial direction 310. Alternatively, in other embodiments a user may be enabled to scroll in a vertical direction 312 in addition to the horizontal direction 310. While two application windows 306A, 306B are illustrated, more or fewer application windows are contemplated.

Referring to FIG. 4, a display incorporating a vertically adjustable user interface is illustrated in accordance with an example of the present disclosure. Similar to FIGS. 2 and 3, the display 400 may output a user interface 402 integrating icons 408 and a first application window 406B. In response to launch of a second application window 306B, the user interface 402 may be adjusted (i.e., expanded) to enable disposition of the second application window 406B in a non-overlapping manner within the expanded user interface 404.

As illustrated, the second application window 406B is currently being output via the display 402. In other words, the expanded user interface 404 is currently in a viewing position for a user. In addition, icons 408 also remain in the viewing area of display 400. In this example, icons 404 are static with respect to the adjustable user interface 404. In order to output the expanded user interface 404 via the display 400, the user interface 402 is moved along vertical axis 410.

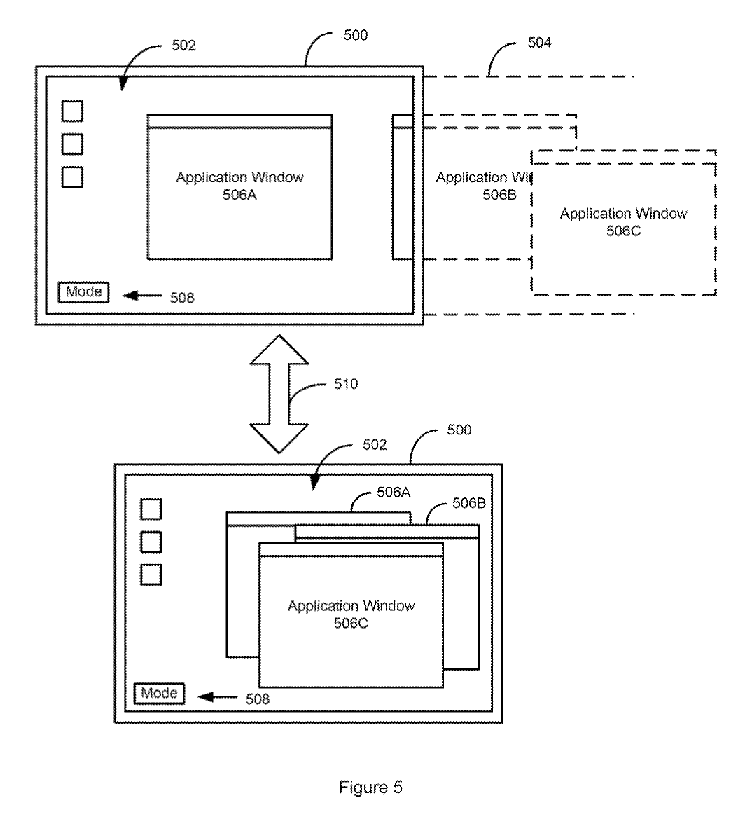

Referring to FIG. 5, two distinct views of display 500 are illustrated in accordance with an example of the present disclosure. Display 500 includes a mode icon 508. In various examples, mode icon 508 may be utilized to transition the display 500 between a user interface adjustable mode and a standard user interface mode. As illustrated, display 500 first includes a user interface 502 and an adjustable (i.e., expanded) user interface 504. The adjustable user interface 504 includes the additional application windows 506B, 506C which are disposed adjacent to the first application window 506A in an overlapping manner.

In response to a user input, for example, a user selecting the user selection mode icon 508, the display may transition 510 to the standard user interface mode. In the standard user interface mode, display 500 may output the first application window 506A and the other application windows 506B, 506C in an overlapping manner within a finite or standard user interface. The transition to the standard user interface mode may dispose various application windows 506A, 506B, 506C in a variety of manners. For example, in one embodiment, the various applications windows 506A, 506B, 506C may be disposed such that at least a portion of each application window is available. In another example, the application windows 506A, 506B, 506C may be disposed such that the most recently utilized application window 506A, 506B, or 506C is active and layered on-top of the other application windows. Other organizing schemes are contemplated.

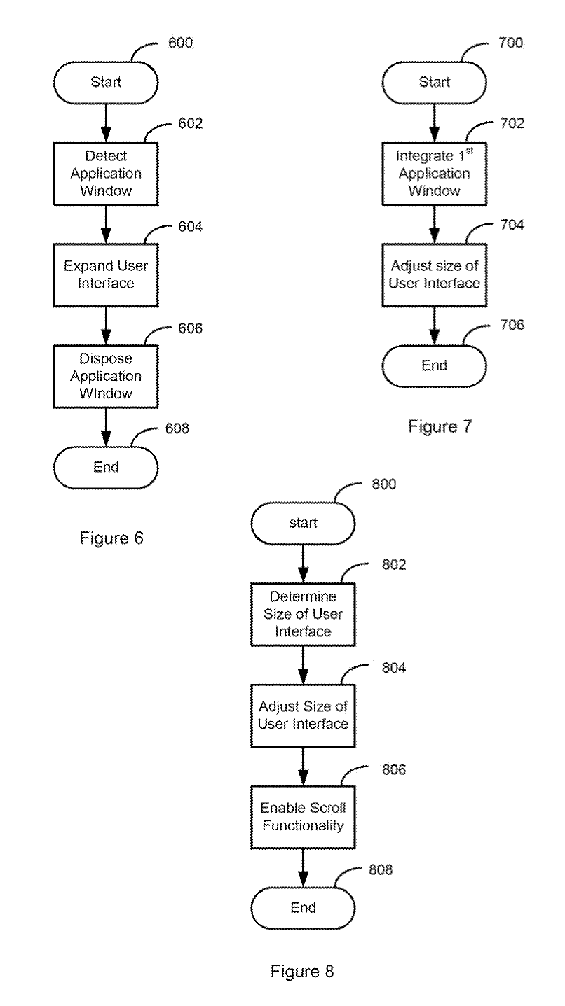

Referring to FIGS. 6-10, various flow diagrams are illustrated in accordance with examples of the present disclosures. The flow diagrams may illustrated steps or elements which may be performed by an apparatus such as the apparatus illustrated in FIG. 1. The flow charts, while illustrating the steps or elements in a particular order are not constrained in such a manner, rather various steps or elements may happen before, after, or simultaneously with other steps or elements. In addition, the various steps or elements, in various examples, may be embodied as programming instructions stored on a tangible, non-transitory computer readable medium, such as that illustrated in FIG. 1.

Referring to FIG. 6, the method may begin at 600 and continue to 602 where a computing device may detect launch of an application window within a user interface output via a display of the computing device. Detecting the launch of the application window may happen via the operating system, a video graphics card, or via instigation of an application.

In response to the launch of the application window, the computing device may adjust the user interface at 604. The adjustment may include expansion of the user interface in one dimension. For example, a user interface may be expanded in a y-dimension (vertical) or an x-dimension (horizontal).

Once the user interface is expanded to account for the launched application window, the computing system may dispose application window adjacent to an existing application window within the expanded user interface. In various examples, adjacent is defined as being next to the existing application. That is the application window may be disposed to the right, the left, on top, or below the existing application. Once disposed adjacent to the existing application, the method may end at 608.

Referring to FIG. 7, another flow diagram is illustrated in accordance with an example of the present disclosure. The method may begin at 700 and continue to 702 where a computing device may integrate a first application window with a user interface. Integrating an application window with a user interface may comprise opening the application window within an area previously defined by the user interface.

In response to the integration, the computing device may adjust the size of the user interface at 704. The adjustment may enable the second application window to be disposed adjacent to the first application window. While disposed in this manner, a combined dimension of the first application window and the second application window may be greater than a dimension of the display. In various examples, the combined dimension of the first application window and the second application window may include spacing between the respective application windows. After adjustment of the user interface, the method may end at 706.

Referring to FIG. 8, another flow diagram is illustrated in accordance with an embodiment of the present disclosure. The flow diagram begins at 800 and progresses to 802 where the computing device may determine whether a user interface is large enough to output a first application window next to a second application window in a non-overlapping manner. The determination may be based on various algorithms including a calculation of the various application window sizes. A non-overlapping manner is defined as a condition where the first application window does not over-lap or touch a portion of the second application window. In other examples, the disposition of the first and second application windows may be such that a portion of the various windows overlap or touch.

Based on a determination the user interface is too small to output the first application window and the second application window in a non-overlapping manner, the computing device may adjust a size of the user interface at 804. Adjusting the size of the user interface at 804 may include expanding the user interface in one dimension. The adjustment may be such that the user interface is large enough to position the first application window adjacent to the second application window.

Once the user interface has been adjusted at 804, the computing device may enable a scroll function within the user interface at 806. The scroll function may enable output of the first application window, the second application window, or a portion of each in response to the user input. The scroll functionality may be continuous such that the launched application windows are displayed in a circular manner. Alternatively, the scroll functionality may be limited to a predefined space, wherein a user pans in both directions within a finite user interface. Once scroll functionality has been implemented, the method may end at 808.

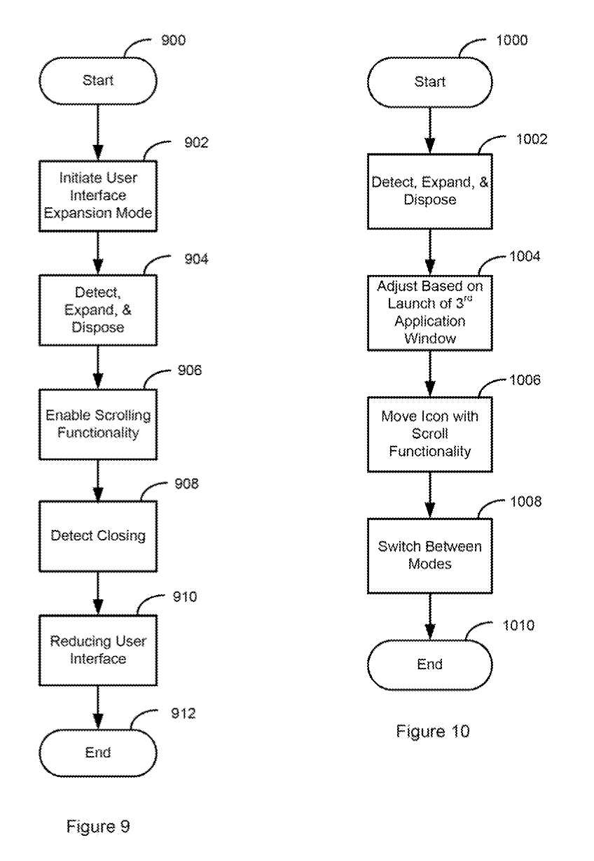

Referring to FIG. 9, another flow diagram is illustrated in accordance with an example of the present disclosure. The flow diagram may begin at 900 and progress to 902 where a computing device may initiate a user interface expansion mode. The user interface expansion mode may be initiated via actuation of an icon, integrated, for example, with the user interface.

In response to initiating the user interface expansion mode, the computing device may detect launch of an application window within the user interface, adjust the user interface in response to the detecting, and dispose the launched application window adjacent to an existing application window at 904. Once disposed, the computing device may enable a scrolling functionality at 906. The scrolling functionality may enable continuous scrolling or alternatively, may enable a user to scroll forwards and backwards to view the various application windows.

At block 908, the computing device may detect closing of an application window. The closing of an application window, either the first application window or the second application window, may occur via actions by the user, the computing device, or another computing device. Upon detecting the closing, the computing device may dynamically adjust the adjustable user interface. In various examples, adjusting the user interface may comprise reducing the user interface. The reduction may be such that the remaining application windows do not overlap. The method may then end at 912.

Referring to FIG. 10, another flow diagram is illustrated in accordance with an example of the present disclosure. The method may begin at 1000 and progress to 1002 where a computing device may detect launch of an application window within the user interface, adjust the user interface in response to the detecting, and dispose the launched application window adjacent to an existing application window at 1002.

Subsequent to block 1002, the computing device may adjust the previously adjusted user interface again based on a detected launch of a third application window at 1004. The third application window may be associated with a currently running application or alternatively new application. The third application window may be disposed adjacent to either the first application window on a side opposite the second application window, or alternatively, may be disposed immediately adjacent to the second application window.

Once disposed, a user may scroll continuously or back and forth across the adjusted user interface. While scrolling, various icons associated with shortcuts associated with various applications may be configured to move with the scrolling such that the icons remain visible regardless of the portion of the adjustable user interface. At 1006.

At 1008, a user may select a mode icon such that the computing device is transitioned to a standard user interface mode. Once selected, the computing device may dispose the various application windows (i.e., first, second, and third application windows) within the user interface disposed within the bounds of the display. The multiple application windows may be disposed in a tiled or layered manner. The layering may occur based upon various usage models including, most used application window on top or last used application window on top. The various application windows may be disposed in a manner such that at least a portion of each application window is concurrently visible with the other application windows. Other examples are contemplated.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of this disclosure. Those with skill in the art will readily appreciate that embodiments may be implemented in a wide variety of ways. This application is intended to cover any adaptations or variations of the embodiments discussed herein. Therefore, it is manifestly intended that embodiments be limited only by the claims and the equivalents thereof.

What is claimed is:

1. A method, comprising:
detecting, by a computing device, launch of an application window within a user interface output via a display of the computing device;
adjusting, by the computing device, the user interface in response to the launch of the application window, wherein the adjusted user interface is expanded in one dimension; and
disposing; by the computing device, the application window adjacent to an existing application window within the expanded user interface.

2. The method of claim 1, further comprising:
scrolling, by the computing device, horizontally through the expanded user interface to output either the application window or the existing application window.

3. The method of claim 1, further comprising:
detecting, by the computing device, closing of the application window within the expanded user interface output via the display; and
reducing, by the computing device, the expanded user interface in response to the closing of the application window.

4. The method of claim 1, further comprising:
initiating, by the computing device, a user interface expansion mode, wherein the user interface expansion mode controls expansion of the user interface in response to detecting launch of the application window.

5. The method of claim 1, further comprising:
deactivating, by the computing device, a user interface expansion mode, wherein the deactivation disposes the application window over of the existing application window.

6. The method of claim 1, further comprising:
detecting, by the computing device, a user selection of an image within a predefined area of the expanded user interface, wherein the image is associated with one of the application window or the existing application window; and
displaying, by the computing device, either the application window or the existing application in response to the user selection.

7. A system, comprising:
an integrator to integrate a first application window with a user interface;
an adjuster coupled to the integrator to adjust a size of the user interface in response to integration of a second application window with the user interface; and
an output module coupled to the adjuster, to output the second application window adjacent to the first application window and wherein a combined dimension of the first application window and the second application window is greater than one dimension of the display.

8. The system of claim 7, further comprising:
a display communicatively coupled to the integrator and adjuster.

9. The system of claim 7, wherein the output module to display either the first application window or the second application window in response to a user selection.

10. The system of claim 9, wherein the user selection is received via interaction with a predetermined area of the adjustable user interface.

11. The system of claim 7, wherein the output module is further configured to enable continuous scrolling through the first application window and the second application window in a single direction.

12. The system of claim 7, wherein the output module is further configured to switch from a user interface expansion mode to a standard user interface mode.

13. The system of claim 7, wherein output module is further configured to move an application icon in accordance with movement of the adjustable user interface, wherein the application icon is continually output via the display.

14. An article of manufacture comprising a non-transitory computer readable medium having a plurality of programming instructions stored thereon, wherein the plurality of programming instructions, if executed by a processor, cause a computing device to:
determine whether a user interface is large enough to output a first application window next to a second application window in a non-overlapping manner;
adjust a size of the user interface in response to a determination that the user interface is too small to output the first application window next to the second application window in a non-overlapping manner; and
enable a scroll function within the user interface, wherein the scroll function is configured to output the first application window or the second application window in response to user input.

15. The article of manufacture of claim 14, wherein the plurality of programming instructions, if executed by the computing device, cause the computing device to:
scroll continuously through the first application window and the second application window in one direction.

16. The article of manufacture of claim 14, wherein the plurality of programming instructions, if executed by the computing device, cause the computing device to:
adjust the size of the user interface in response to a launch of a third application window; and
output a portion of the user interface corresponding to the third application.

17. The article of manufacture of claim 14, wherein the plurality of programming instructions, if executed by the computing device, cause the computing device to:
switch between a user interface adjustable mode and a standard user interface mode in response to user input.

18. The article of manufacture of claim 14, wherein the plurality of programming instructions, if executed by the computing device, cause the computing device to:
adjust the size of the user interface horizontally.

19. The article of manufacture of claim 14, wherein the plurality of programming instructions, if executed by the computing device, cause the computing device to:
adjust the size of the user interface vertically.

20. The article of manufacture of claim 14, wherein the plurality of programming instructions, if executed by the computing device, cause the computing device to:
move an application icon in accordance with the scroll function.
